(19) United States
(12) Patent Application Publication
(10) Pub. No.: US 2012/0135734 A1
(43) Pub. Date: May 31, 2012

(54) METHOD AND APPARATUS FOR PROVIDING DATA TO A MOBILE DEVICE

(75) Inventors: Qian Ma, Beijing (CN); Rui X. Tian, Beijing (CN); Yi B. Zhang, Beijing (CN); Yan F. Zhu, Beijing (CN)

(73) Assignee: INTERNATIONAL BUSINESS MACHINES CORPORATION, Armonk, NY (US)

(21) Appl. No.: 13/301,309

(22) Filed: Nov. 21, 2011

(30) Foreign Application Priority Data
Nov. 26, 2010 (CN) 201010574933.3

(51) Int. Cl. H04W 36/00

(52) U.S. Cl. 455/436

(57) ABSTRACT

A method for providing data to a mobile device, includes predicting a list of cells to which a mobile device is to be handed over during a predetermined time period; determining bandwidth that is available to the mobile device from at least one cell in the list; calculating traffic that is available to the mobile device from the at least one cell in the list based on the bandwidth; and providing data to the mobile device based on a coding scheme that matches the traffic. There is also provided an apparatus for providing data to a mobile device.

### RELATED APPLICATION DATA

This application claims priority to People's Republic of China Patent Application No. 201010574933.3 filed on Nov. 26, 2010, and incorporated herein by reference.

### TECHNICAL FIELD

Embodiments of the present invention relate to data processing and more particularly to a method of and an apparatus for providing data to a mobile device, and a related computer program product.

### BACKGROUND

Evolution of mobile communication technology provides a more convenient data transmission manner for massive users. Nowadays, functions of a mobile communication device are no longer limited to traditional services such as voice communication services, instant messaging service, and multi-media message service. Further, with the enhancement of communication and computation capabilities of the mobile device itself, the mobile device may send, receive and process various kinds of data at any place and at any time.

However, in mobile communication, since a mobile device is in a mobile state, the bandwidth provided by different cells to the mobile device is not always identical. When a mobile device is in a transportation vehicle moving at a high speed or located in a handover area overlapped with different cells, frequent handover might occur among cells. At this point, for data transmission (for example, a video stream) with a high demand on real-time performance, it is more desirable to guarantee reliable provision of required data to the mobile device.

In order to facilitate a user to watch uninterrupted video, one solution is to set a video buffer to a video stream previously transmitted to a play device. However, although a buffer set in the mobile device may mitigate the interruption phenomenon to some extent during the playing of multimedia data such as video; it cannot solve the problem of inconsistent available bandwidth in different cells when the mobile device undergoes handover among different cells.

### SUMMARY

Therefore, providing data to a mobile device with the fewest changes to an existing configuration becomes an imminent problem to solve. To this end, there is provided a method and an apparatus for providing data using a suitable coding scheme by comparing available traffic from respective cells with required traffic by a mobile device during a predetermined period of time, and a related computer program product.

In an embodiment, there is provided a method for providing data to a mobile device. The method comprises: predicting a list of cells to which a mobile device is to be handed over during a predetermined time period; determining bandwidth that is available to the mobile device from at least one cell in the list; calculating traffic that is available to the mobile device from the at least one cell in the list based on the bandwidth; and providing data to the mobile device based on a coding scheme that matches the traffic.

In another embodiment, predicting a list of cells to which a mobile device is to be handed over during a predetermined time period and comprises: obtaining a historical sequence of cells that the mobile device has passed, road network information within the passed cells and their adjacency; predicting a cell to which the mobile device is to be handed over during a predetermined time period based on the historical sequence and road network information to add it into the list.

In another embodiment, the list comprises at least information on identification of a cell to which the mobile device is to be handed over and information on sojourn time in the cell.

In another embodiment, there is provided an apparatus for providing data to a mobile device. The apparatus comprises: means for predicting a list of cells to which a mobile device is to be handed over during a predetermined time period; means for determining bandwidth that is available to the mobile device from at least one cell in the list; means for calculating traffic that is available to the mobile device from the at least one cell in the list based on the bandwidth; and means for providing data to the mobile device based on a coding scheme that matches the traffic.

In another embodiment, means for predicting a list of cells to which a mobile device is to be handed over during a predetermined time period comprises: means for obtaining a historical sequence of cells that the mobile device has passed and road network information within the passed cells and their adjacency; and means for predicting a cell to which the mobile device is to be handed over during a predetermined time period based on the historical sequence and road network information for adding into the list.

In another embodiment, the list comprises at least information on identification of a cell to which the mobile device is to be handed over and information on sojourn time in the cell.

According to embodiments of the present invention, with the fewest changes to the hardware configuration of a mobile communication device, data with acceptable quality may be conveniently and reliably provided to a user of the mobile device continuously and smoothly, and configuration to a mobile communication network may be implemented with easy deployment. According to the embodiments, it is also possible to mitigate contradictions between inconsistency in bandwidth that are available to the mobile device from different cells and provide an expectation of continuously acceptable quality data to a user of the mobile device.

### BRIEF DESCRIPTION OF THE DRAWINGS

Features, advantages, and other aspects of various embodiments of the present invention will become more apparent through the following detailed description with reference to the following drawings, wherein:

FIG. 1 schematically illustrates an architecture of an application environment in which embodiments of the present invention may be implemented;

FIG. 2 schematically illustrates a motion of a mobile device crossing different cells according to an embodiment of the present invention;

FIG. 3 schematically illustrates a flow chart of a method for providing data to a mobile device according to an embodiment of the present invention;

FIG. 4 schematically illustrates a flow chart of a method for predicting a list of cells to which a mobile device is to be handed over during a predetermined time period according to an embodiment of the present invention;

FIG. 5 schematically illustrates a specific instance for predicting a list of cells to which a mobile device is to be handed over during a predetermined time period according to an embodiment of the present invention;

FIG. 6 schematically illustrates a diagram for selectively providing data to a mobile device using different coding schemes during a predetermined time period according to an embodiment of the present invention; and

FIG. 7 schematically illustrates a diagram of a system for providing data to a mobile device with a variable coding rate according to an embodiment of the present invention.

### DETAILED DESCRIPTION OF THE PREFERRED EMBODIMENTS

Hereinafter, various embodiments of the present invention will be described in detail with reference to the drawings.

The flowcharts and block diagrams in the figures illustrate the system, methods, as well as architecture, functions and operations executable by a computer program product according to the embodiments of the present invention. In this regard, each block in the flowcharts or block diagrams may represent a module, a program segment, or a part of code, which contains one or more executable instructions for performing specified logic functions. It should be noted that, in some alternative implementations, the functions marked in the blocks may also occur in a sequence different from what is marked in the drawings. For example, two blocks as illustrated consecutively may be performed in parallel substantially or in an inverse order. This depends on relevant functions. It should also be noted that each block in the block diagrams and/or flowcharts and a combination of blocks in the block diagrams and/or flowcharts may be implemented by a dedicated hardware-based system for performing specified functions or operations or by a combination of dedicated hardware and computer instructions.

In one embodiment, one or more of cells to which a mobile device is to be handed over during a predetermined period of time are predicted. It is determined how much bandwidth is available to the mobile device from at least one cell. Scalable coding is performed on data to be transmitted to the mobile device using a scheme that matches a bandwidth of each cell.

Hereinafter, a processing flow of a method and a working principle of a corresponding apparatus according to embodiments will be illustrated in detail with an example of providing multimedia data to a mobile terminal. It should be noted that according to an embodiment of the present invention, various methods, apparatuses, and computer program products are not only applicable to providers of multimedia services, but also applicable to various kinds of service providers of other data services in a mobile communication network.

For multimedia data transmission, particularly video stream transmission, it is usually hard for users to bear interrupted playing conditions. Compared with poorer picture quality, it is usually more difficult for users to endure interruption during playing. It should be noted that when a user plays video data with a mobile device, the most desirable thing is consistently and constantly maintain high-bandwidth transmission without interruption. If such transmission cannot be implemented, usually, a preferred priority sequence for the user is: middle bandwidth transmission without interruption, low bandwidth transmission without interruption, high bandwidth transmission with interruption, middle bandwidth transmission with interruption, and low bandwidth transmission with interruption.

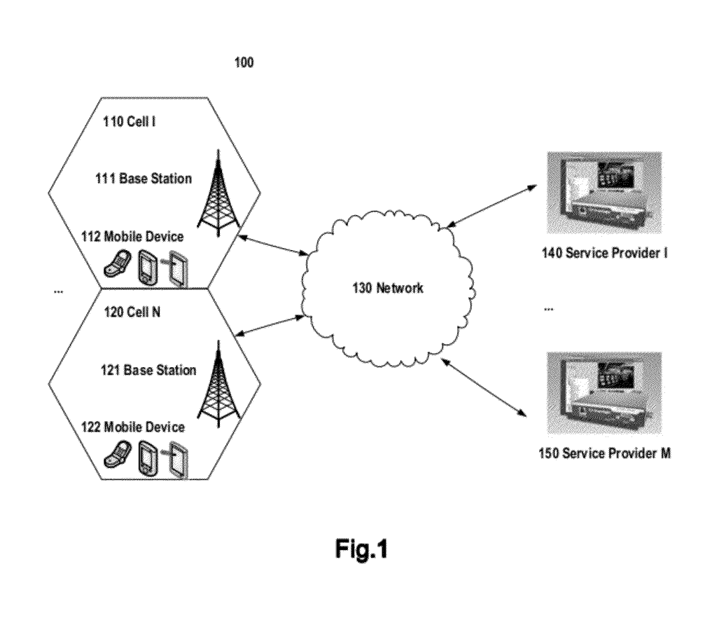

FIG. 1 schematically illustrates an architecture of an application environment in which embodiments of the present invention may be implemented. It should be understood that FIG. 1 only schematically illustrates two cells for performing mobile communication, i.e. a cell I 110 and a cell N 120, and there may be other cells used for mobile communication. As illustrated in FIG. 1, a service provider I 140 and a service provider M 150 may communicate with a mobile device 112 in the cell I 110 and a mobile device 122 in the cell N 120 via a network 130 and base stations 111 and 121, respectively. It should be noted that the mobile device as illustrated may be handed over among different cells. For example, the mobile device 112 may be handed over from the cell I 110 to the cell N 120 or other cells. FIG. 1 only illustrates a circumstance in which the mobile device is currently in a particular cell. Usually, when the mobile device moves at a high speed (for example, in a transportation vehicle moving at a high speed), the mobile device will be handed over between different cells frequently. At this time, it is particularly necessary to guarantee that the mobile device may play multimedia data continuously without interruption or with as few interruptions as possible.

It should be further noted that although the specification uses a mobile station as a specific example of a mobile device, it should be understood that the mobile device may further comprise, for example, a PDA, a smart phone, and a portable game device, etc. Besides, with the trend of computing device minimization and gradual merging with a mobile device, the mobile device may further comprise various kinds of mobile computing devices having functions of wireless network transmitting and receiving functions, such as a portable computer, etc.

It should be noted that although the specification adopts a service provider as an example of an entity providing data to a mobile device with variable coding rate, the service provider in the present invention is not limited to a professional data provider supplying various kinds of data, but may also comprise other entities such as individuals and organizations. Embodiments of the present invention are not limited to the location of the service provider or the content of the provided data, but focus on how to provide data to a mobile device with a variable coding rate.

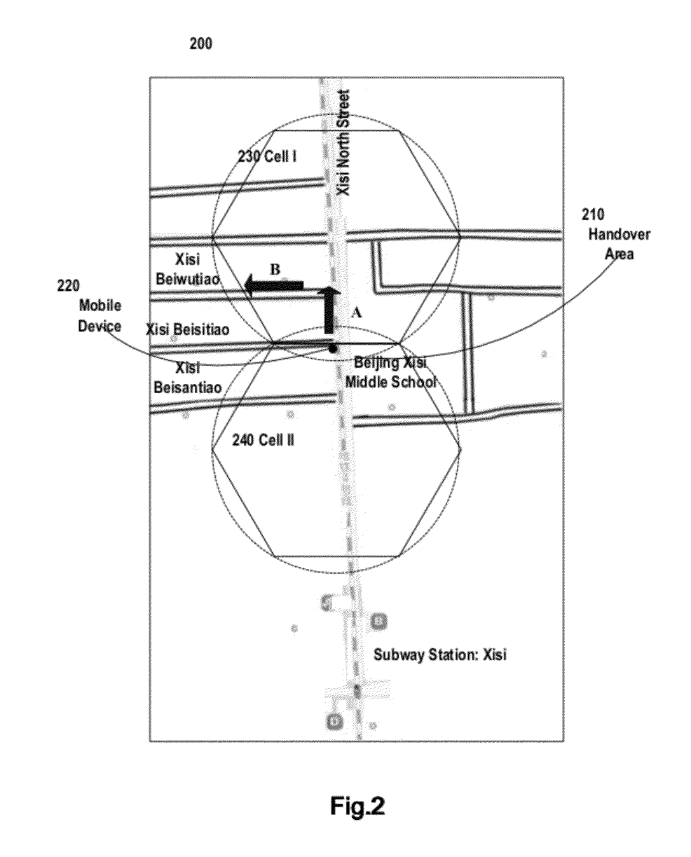

FIG. 2 schematically illustrates a diagram 200 of motion of a mobile device crossing different cells according to an embodiment of the present invention. FIG. 2 illustrates coverage of a cell I 230 and a cell II 240 in a dotted line, respectively. When a mobile device 220 is in overlapped scope between the cell I 230 and cell II 240, it is currently in a handover area 210 of the two cells. If the mobile device 220 continues to move in a direction illustrated by arrow A, then it will be handed over from the cell II 240 to the cell I 230.

It should be understood that whether a smooth video playing effect is achieved is generally dependent on the size of available bandwidth to the mobile device as well as on the amount of data that have been buffered in the buffer of the mobile device. The available bandwidth of the mobile device is related to the mobile device's current data receiving rate, while the data amount in the buffer is related to the duration of smooth playing that may be further enabled in the case that the mobile device does not receive new data. In view of the problem of difficultly providing continuous and smooth video play to a mobile device that is continuously taking handovers among cells in the prior art, the present invention proposes a method of stably provide continuous and smooth video play to a mobile device. The method comprises: pre-estimating available bandwidth and available traffic of a cell to which the mobile device is to be handed over during a predetermined time period, and providing data to the mobile device in a suitable coding scheme based on the available traffic.

Within coverage of different cells, the bandwidth available to the mobile device is usually different. In order to enable the mobile device to achieve a smooth video effect during the cell handover process, it is needed to predict available bandwidth level of a cell at which the mobile device is to arrive during a next time period.

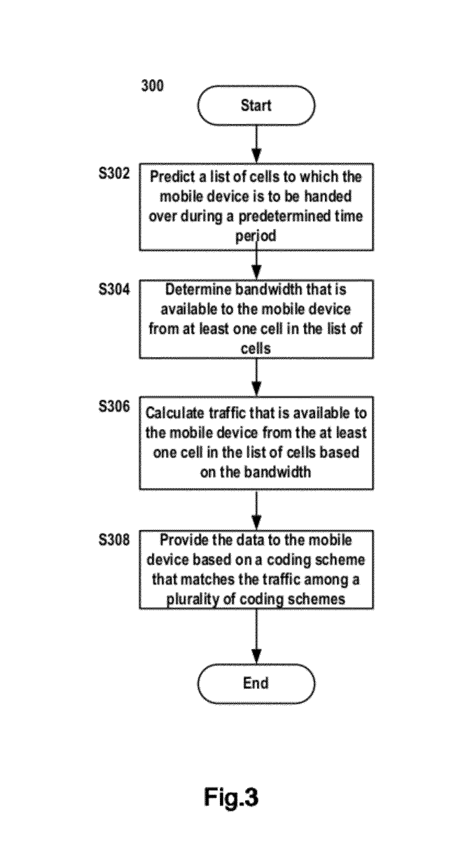

FIG. 3 schematically illustrates a flow chart 300 of a method for providing data to a mobile device according to an embodiment of the present invention. As illustrated in FIG. 3, at step 302, a list of cells to which the mobile device is to take handovers during a predetermined time period is first predicted. It should be noted that the “predetermined period of time” here refers to the time period during which a user expects to guarantee that a smooth video effect may be achieved. The numerical value of the “predetermined time period” may be set by the user himself/herself or may use a predefined default value. For example, if the value is set to 5 minutes, it may be deemed that in the incoming 5 minutes, the mobile device may achieve a smooth video effect.

It should be understood that to set the “predetermined time period” to be 5 minutes here does not mean it is necessary to buffer 5-minute or longer video data in the data buffer of the mobile device, but that it may guarantee that the incoming 5 minutes of video data may be played continuously and smoothly through a prediction mechanism; in other words, the provisioning speed of video data (including the video having been stored in the buffer and the video to be received to the mobile device before an expected playing time) may satisfy the playing speed of video data. It should be further noted that to set the “predetermined time period” to be 5 minutes here does not mean in the “next” 5 minutes, the available bandwidth for the mobile device at any time satisfies the bandwidth needed for real-time receiving and playing of the video data. For the entire time period of 5 minutes, the provisioning speed of video data may satisfy the playing speed of video data.

It should be understood that achieving a smooth video effect does not mean continuously and smoothly receiving video data. If the mobile device may continuously and smoothly receive video data, then at this point, a smooth video effect may be achieved. However, if the mobile device cannot receive video data continuously and smoothly, it does not necessarily result in an unsmooth video effect; because of the existence of a data buffer, if a great amount of video data is buffered therein, a smooth video effect may likely be achieved even if the receiving rate of the mobile device is zero.

In one embodiment, a buffer for buffering video data may be set. For example, such situation may exist where the user sets the “predetermined time period” to be 5 minutes, but since the mobile device's available bandwidth in the first 4 minutes is relatively high, video data available for playing for 5 minutes or longer may have been received in the first 4 minutes. Thus, although the available bandwidth in the last 1 minute is relatively low (for example, in the last 1 minute, all available bandwidth at any second is lower than the bandwidth needed for playing the video data), since enough video data may have been buffered in the buffer, the mobile device can still play the video continuously and smoothly in the incoming 5 minutes. At this point, the data received in the last 1 minute may be data of video for playing the next “predetermined time period.” When the data in the buffer are exhausted and the current available bandwidth is lower than the bandwidth needed for real-time playing video data, an interruption phenomenon may occur in the playing.

In an embodiment, the length of “predetermined time period” may be dynamically set as desired by the user, or may be automatically, dynamically set based on the communication capacity of the cell adjacent to the cell where the mobile device is located and/or information is on a nearby network. For example, when all cells in the list of predicted cells have a good communication capacity, a greater “predetermined time period” may be set; on the other hand, when the communication capacities of the cells in the list are uneven, a smaller “predetermined time period” may be set. Other policies may also be employed to set the “predetermined time period.”

At step S304, available bandwidth to the mobile device from at least one cell in the list is determined. In one embodiment, the “available bandwidth” here may refer to a typical bandwidth achieved in the predetermined time period or refer to a predicted transient bandwidth available at each moment in the time period during which it resides in a particular cell. The objective of introducing such available bandwidth is to calculate available traffic in at least one cell and then to calculate the total available traffic in all cells in the list.

At step S306, available traffic to the mobile device from at least one cell in the list is calculated based on the bandwidth. According to various embodiments of the present invention, hereinafter, how to calculate available traffic directed to a typical available bandwidth and transient available bandwidth will be described in detail.

At step S308, a coding scheme matching with the traffic is selected from a plurality of coding schemes so as to provide data to the mobile device. It should be noted here that according to the method of the present invention, the data may be encoded with a plurality of coding schemes. For example in the case of video data, coding may be performed in a scalable coding scheme. In the case of employing different coding schemes, for a plurality of levels from a basic layer to an enhanced layer, video data may be encoded hierarchically, where only the data in the basic layer are transmitted when the bandwidth is insufficient. Although the video transmission quality at this point is not high, it may satisfy the user's most fundamental viewing requirement. When the bandwidth is gradually increased, the data in the enhanced layer may be transmitted to improve video quality. In one embodiment, based on an encoding scheme matching the traffic in a plurality of encoding schemes, video playing with higher picture quality without interruption is provided to the mobile device during a predetermined time period.

It should be noted that in this embodiment, the “traffic” available to the mobile device from at least one cell in the list is calculated by considering the bandwidth available from at least one cell. The “traffic” is the total available traffic during the predetermined time period. It is only needed that the available total traffic be higher than the needed total traffic, but it is not necessary that the available bandwidth is higher than the bandwidth needed for real-time transmitting and playing the video data at any moment during the predetermined time period.

It should be further noted that when the communication capacity of one or more cells is so poor that the available bandwidth in the cell is nearly zero, the video data buffered in the buffer may be continued to play. When the data in the buffer is “exhausted,” if the mobile device is still located in the cell with extremely low available bandwidth, then the phenomenon will be that the video play has basically stopped or the delay is very serious, and video transmission can only be restored normally until the available bandwidth of the cell rises, or the mobile device is handed over into other cells that have better communication capability. After the cell's communication capability resumes normal, a next round of predicting, determining, calculating and providing operations may be performed according to the method of the embodiment of the present invention.

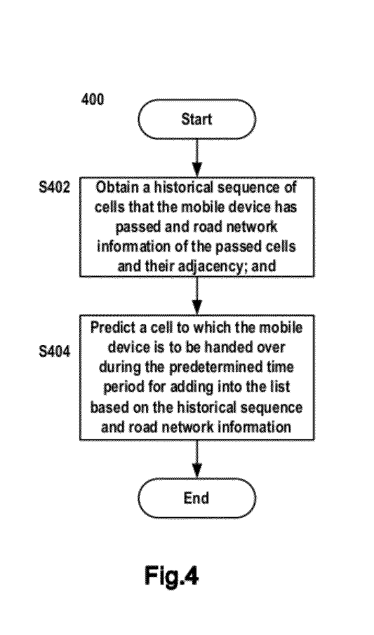

FIG. 4 schematically illustrates a flow chart 400 of a method for predicting a list of cells to which a mobile device is to be handed over during a predetermined time period according to an embodiment of the present invention. In one embodiment, at step S402, a historical sequence of the cells along which the mobile device passes and the road network information within the passed cells and their adjacency are obtained. For example, the sequence of the passed cells may be obtained based on state information of the mobile device, where the state information may comprise historical locations of the mobile device, current locations of the mobile device, moving speed and moving directions of the mobile device, etc.

Such state information may be obtained in various different manners. For example, a dedicated application may be installed in the mobile device so as to report its own current location at any time; a current location of each mobile device may be obtained from a server of a mobile service provider; and a current location of the mobile device in the cell may also be obtained at a base station of each cell, etc. Based on different embodiments, different mechanisms may be employed to achieve a historical sequence of the cells along which the mobile device passed.

The method according to embodiments of the present invention is not performed only by a provider of a mobile communication service, but may be also performed by a service provider or other organization, as long as it may obtain the data of predicting the list of cells to which the mobile device is to be handed over and obtain available bandwidth from at least one cell in the list. For example, a video service provider, a professional intermediary organization or individual providing data to the mobile device with a variable coding rate can implement the method and apparatus for providing data to the mobile device according to the present invention.

The road network information here refers to information on various kinds of paths suitable for traveling of transportation tools or walking of people. For example, highway, road, street, etc., related to terrestrial transportation, and underground transportation (for example, subway), water surface transportation (for example, rivers, lakes, ocean transportation), and even air transportation (for example, airline).

At step S404, based on the historical sequence and road network information, a cell to which the mobile device is to be handed over during a predetermined time period is predicted to add it into the list. One objective of considering the road network information is to predict the road along which the mobile device is traveling based on the historical location information of the mobile device and add the cells along which the road passes into the cell list.

To further illustrate step S404, reference is made back to FIG. 2. As illustrated in FIG. 2, for example, if it is determined that the mobile device is moving along a subway line toward a direction indicated by arrow A based on the historical location information obtained from the mobile device 220, the next cell (namely, cell I 230) along the subway line may be added into the cell list. For another example, when the current location and moving direction of the mobile device 220 shows that the mobile device 220 is moving along the direction as illustrated by arrow B, then it may be determined that the mobile device 220 has left the subway and is moving westward along the “Xisi Beiwutiao” Street. At this point, a cell where the “Xisi Beiwutiao” is located (not illustrated in FIG. 2) is added into the cell list. In one embodiment, the cell to which the mobile device is to be handed over may be predicted more conveniently and accurately with reference to the historical sequence of the cells along which the mobile device passed and using the road network information within the passed cell and their adjacent cells.

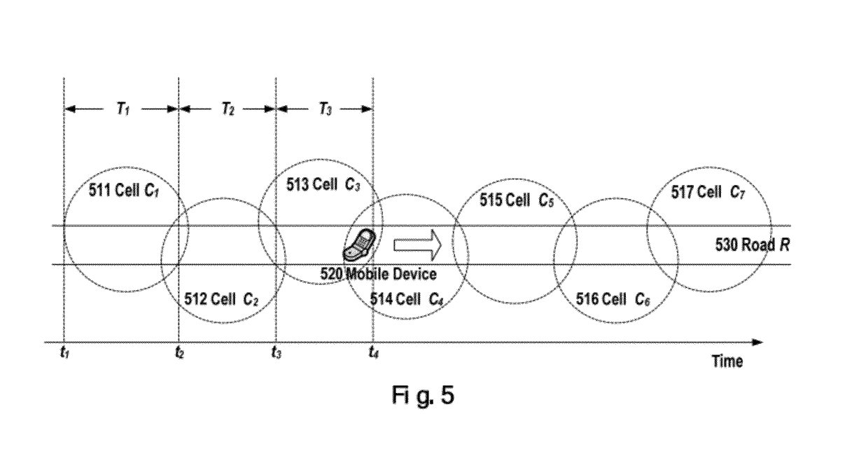

In an embodiment, the list at least comprises information on identification of a cell to which the mobile device is to be handed over and information on sojourn time in the cell. Hereinafter, a specific instance for predicting will be described with reference to FIG. 5. As illustrated in FIG. 5, the mobile device 520 is moving along the road R as indicated by the arrow illustrated in the figure. The cells along the road R 530 are cell C₁ 511, cell C₂ 512, cell C₃ 513, cell C₄ 514, cell C₅ 515, cell C₆ 516, and cell C₇ 517, respectively. At this point, the mobile device 520 has passed the cell C₁ 511, cell C₂ 512 and cell C₃ 513.

The list of cells to which the mobile device 520 is to be handed over may be predicted based on the current location of the user (namely the current cell where the mobile device 520 is located), the moving speed and moving direction of the mobile device 520. The current location of the mobile device 520 is known, and moreover, the moving speed and moving direction of the mobile device 520 may be obtained from the mobile device 520 itself or from the mobile communication network based on the above method. Next, the identifications of the cells along which the mobile device passes and corresponding time may be recorded, as indicated in the following Table 1.

TABLE 1
List of Cells

| Serial Number | Cell Identification | Time |
|---|---|---|
| 1 | 25357 | 192428 |
| 2 | 32853 | 192603 |
| 3 | 8249 | 193041 |
| 4 | 32853 | 193115 |
| 5 | 8249 | 193152 |
| 6 | 25302 | 193204 |
| 7 | 4626 | 193228 |
| 8 | 8393 | 193238 |
| 9 | 8249 | 193302 |
| 10 | 8249 | 193326 |
| 11 | 32851 | 193503 |
| 12 | 34082 | 193541 |
| 13 | 34081 | 193947 |
| 14 | 34082 | 194010 |
| 15 | 3612 | 194219 |

The “Cell Identification” column in Table 1 records identifications of the cells along which the mobile device passes, while the “time” column records the time when the mobile device enters into the cell indicated in the second column. It should be noted that the column “Cell Identification” in Table 1 lists the cell identifier indicated by a digital serial number, and different serial numbers indicate different cells. According to other embodiments of the present invention, the identifier may further comprise an additional field to express other information, for example, the geographical location of the cell, the coverage of the cell, and the level of the communication capacity of the cell, etc. The “time column” in Table 1 records time in a format of “hour/minute/second.” For example, the row with a serial number “1” indicates that the mobile device enters into a cell with an identifier of 25357 at 19:24:28.

It is known from Table 1 that:

Tᵢ=tᵢ₊₁−tᵢ Equation (1)

wherein Tᵢ indicates the sojourn time of the mobile device in the cell Cᵢ, tᵢ₊₁ indicates the time upon which the mobile device enters into a next cell, while tᵢ indicates the time when the mobile device enters into the current cell. It should be noted that in this description, the “i” and “j” in the subscripts are both positive integers.

For example, a 2-tuple (Cᵢ,Tᵢ) indicates information about each cell, and this 2-tuple means the sojourn time of the mobile device 520 in cell Cᵢ is Tᵢ. After obtaining a sequence of a plurality of cells along which the mobile device 520 has passed, the road where the mobile device 520 is currently located may be derived (for example, it may be deduced that the mobile device 520 is moving along the road R 530). The reason is that a cell's coverage is relatively fixed, and if the mobile device 520 moves along a given road, then the sequence of cells along which the mobile device 520 passes is relatively fixed, and therefore the distance crossing each cell (i. e., the overlapped length between the cell Cᵢ and road R 530) is relatively fixed.

Referring back to FIG. 5, it is assumed that the mobile device 520 is moving along the road R 530 and the sequence of cells which have been passed and are to be passed is (C₁,C₂,C₃,C₄,C₅,C₆,C₇), then based on differences in moving states, the sojourn time of the mobile device 520 in each cell is different. For a given road R 530, the overlap length between the road R 530 and the cell Cᵢ is expressed as L(R,Cᵢ). In the case that the sojourn time Tᵢ of the mobile device 520 in cell Cᵢ is known, the passing speed of the mobile device 520 is L(R,Cᵢ)/Tᵢ.

Continuing to refer to FIG. 5, it is assumed that the current time is t and the mobile device 520 is currently located in the cell C₃ 513, and it is known from the historical records that the sequence of cells along which the mobile device 520 has previously passed is (C₁,C₂,C₃), then the time of entering into each cell is (t₁,t₂,t₃), respectively. Because the mobile device 520 has completely passed through the cell C₁ 511 and C₂ 512, it may be deduced that the mobile device 520 passes along the road R 530 and is leaving the cell C₃ 513 to enter into the cell sequence (C₄,C₅,C₆,C₇). It may be estimated that the passing speed of the mobile device 520 at the current moment is:

s(t)=(L(R,C₁)+L(R,C₂))/(T₁+T₂) Equation (2)

wherein, T₁=t₂−t₁ and T₂=t₃−t₂.

Next, it may be calculated that the remaining sojourn time of the mobile device 520 in the cell C₃ 513 is L(R,C₃)/s(t)−(t−t₃), and the remaining time here refers to the time period during which the mobile device 520 continues to reside in the cell C₃ 513. Accordingly, during the time period from the moment t to L(R,C₃)/s(t)+t₃, the mobile device 520 will be located in the cell C₃ 513. During the time period from the moment L(R,C₃)/s(t)+t₃ to the moment L(R,C₄)/s(t)+L(R,C₃)/s(t)+t₃, the mobile device 520 will be located in the cell C₄ 514. And so forth, it may be calculated that the time period during which the mobile device 520 resides in the cell Cᵢ(i>3) is from

$${t}_{3} + {\sum }_{j = 3}^{i - 1} L ( R , {C}_{j} )$$

to

$${t}_{3} + {\sum }_{j = 3}^{i - 1} L ( R , {C}_{j} ) .$$

It should be noted that the estimated speed s(t) may be dynamically updated with the mobile device 520 passing through a new cell, such that the estimation on the mobile device 520's speed is more accurate.

In one embodiment, determining the bandwidth of the mobile device available from at least one cell in the list comprises: determining the bandwidth based on at least one of the following items: communication capacity, user density, and average channel quality of the at least one cell. The above three affecting factors may be obtained through monitoring the runtime states of the mobile cells, for example obtaining the above information by querying a server in the mobile communication network; or a dedicated device may be set to collect the above information in real time or regularly from the mobile communication network.

It should be understood that if the total available bandwidth of a cell is limited, the available bandwidth assigned to each mobile terminal in the cell will be limited. The stronger the cell's communication capacity is, the lower the user density is, and the higher the average channel quality is, then the higher the available bandwidth of a mobile terminal in the cell is; the lower the available bandwidth of the mobile terminal is. According to another embodiment of the present invention, other factors may also be considered when calculating the available bandwidth.

It is known that since various factors affecting the available bandwidth will vary with time, the available bandwidth of the mobile device at different times is not constant, and further, because the locations of the mobile device in the cell are also different, the available bandwidth might also be affected. In one embodiment, factors affecting the available bandwidth from the cell may be simplified, and a typical bandwidth bᵢ is employed as the available bandwidth in the cell Cᵢ. In one embodiment, a typical bandwidth bᵢ of each cell may be dynamically updated regularly based on the above plurality of affecting factors so as to simplify the operation while trying best to guarantee the accuracy of calculation.

In one embodiment, a transient bandwidth available at each moment during the time period of sojourn in a particular cell may also be calculated in real time. The transient bandwidth here is a function b(t) associated with the time and the above plurality of factors, and the result calculated in this manner is more accurate but slightly more complex. In one embodiment, the above Table 1 may further comprise a column indicating the bandwidth of the mobile device available from each cell.

In one embodiment, in order to further simplify calculation, respective cells in the mobile communication network may be further grouped, i.e., dividing cells with similar conditions into the same group, and employing a representative group bandwidth to indicate the bandwidth available in each cell in the group to the mobile device. For example, grouping may be performed based on factors such as adjacency of geographical locations of cells, and similarity in cells' communication capacities.

In one embodiment, calculating available traffic to the mobile device from the at least one cell in the list based on the bandwidth comprises: calculating the traffic based on the determined bandwidth available to the mobile device from the at least one cell in the list and the expected sojourn time of the mobile device in the at least one cell in the list. The traffic here indicates the total data transmission capacity available to the mobile device from one or more cells in the list of cells to which it is to be handed over during a predetermined time period, so as to select a coding scheme for providing data in subsequent operations.

As mentioned above, according to various embodiments of the present invention, different manners may be adopted to describe the bandwidth available to the mobile device from each cell, thus the methods of calculating the available traffic of the mobile device are also different. Suppose the predetermined time period is T, when a typical available bandwidth is employed, the following equation might be used to calculate the available traffic to the mobile device during a predetermined time period:

$${\sum }_{i = 0}^{K} {b}_{i} {T}_{i} \qquad Equation ( 3 )$$

wherein,

$${\sum }_{i = 0}^{K} {T}_{i} = T ,$$

bᵢ indicates an available bandwidth of the mobile device in cell Cᵢ, while Tᵢ indicates the sojourn time of the mobile device in cell Cᵢ, and the total time of the mobile device sojourn in all cells C₁ to C_{K} in the list is equal to the predetermined time period T, where K is a positive integer.

When a transient available bandwidth is employed, the following equation might be used to calculate the available traffic to the mobile device during a predetermined time period:

$${\int }_{0}^{T} b ( t ) d t \qquad Equation ( 4 )$$

wherein b(t) indicates the transient available bandwidth or bandwidth estimation of the mobile device at the time t, where T indicates the predetermined time period. Those skilled in the art may appreciate that in the sense of mathematical expression, the above summing Equation (3) may be a special case of the integral Equation (4). Therefore, in the following steps of selecting a coding scheme, only the manner of obtaining the traffic with the integral solution is taken as an example, and those skilled in the art may similarly implement a calculation with respect to Equation (3).

In one embodiment, providing data to the mobile device based on a coding scheme matching the traffic comprises: selecting a coding scheme where traffic as required by the mobile device for providing data during a predetermined time period does not exceed, but is closest to, the traffic. A suitable coding scheme may be selected based on the following formula:

$${\int }_{0}^{T} b ( t ) d t \geq {\int }_{0}^{T} B ( t ) d t \qquad Equation ( 5 )$$

wherein B(t) indicates the bandwidth required by the mobile device for smoothly playing video at time t. In other words, this expression means that a coding scheme should be selected where traffic as required by the mobile device for providing data during a predetermined time period does not exceed, but is closest to, the traffic.

In one embodiment, the encoding scheme comprises a scalable encoding scheme. In one embodiment, the data comprise multimedia data. In one embodiment, the multimedia data comprise a video stream.

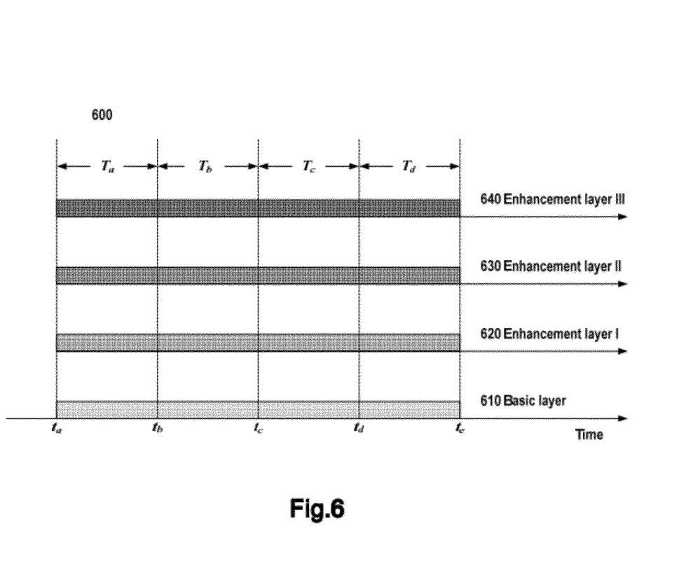

Hereinafter, how to select a proper coding scheme to provide data will be described in detail with reference to FIG. 6. FIG. 6 schematically illustrates a diagram 600 of selecting to provide data to a mobile device in different coding schemes during a predetermined time period according to an embodiment of the present invention. For a video as a typical representative of multimedia data, a scalable video coding scheme may be adopted, as illustrated in FIG. 6. For example, a basic layer 610, an enhancement layer I 620, an enhancement layer II 630, and an enhancement layer III 640 may be set, where the data at the basic layer 610 may carry basic video content, but the video image quality obtained from the data in the basic layer 610 is rather poor.

If the available traffic at a predetermined time period is relatively low, transmitting the data corresponding to the basic layer 610 may guarantee that the mobile device may receive watchable and relatively smooth video stream despite of a poor picture quality. If the available traffic during a predetermined time period is relatively high, a higher coding scheme matching the available traffic may be selected so as to provide data (for example providing enhancement layer data) to the mobile device, thereby improving frame rate, resolution, or video quality, etc. The enhancement layer may be multi-layer encoded. As illustrated in FIG. 6, for the enhancement layer I 620, enhancement layer II 630, and enhancement layer III 640, their video qualities improve in order.

As illustrated in the X-axis “time” of FIG. 6, during the predetermined time period Tₐ between time tₐ and time t_{b}, if the available traffic of the mobile device is rather small, then it may select only to transmit data corresponding to the basic layer 610 during this time period Tₐ. During the predetermined time period T_{b} between the time t_{b} and the time t_{c}, if the available traffic to the mobile device starts to improve but is not sufficient to transmit the data corresponding to the enhancement layer II 630, then it may select to transmit data corresponding to the enhancement layer I 620 during this time period T_{b}. In another example, during the predetermined time period T_{d} between the time t_{d} and the time tₑ, if the available traffic to the mobile device is sufficient to transmit video data of the highest quality, then it may select to transmit data corresponding to the enhancement layer III 640 during this time period T_{d}.

In one embodiment, the predetermined time periods Tₐ to T_{d} as illustrated in FIG. 6 may be identical, or set to be different values by a user or in another manner so as to enable the user to achieve a best effect as needed or according to specific conditions.

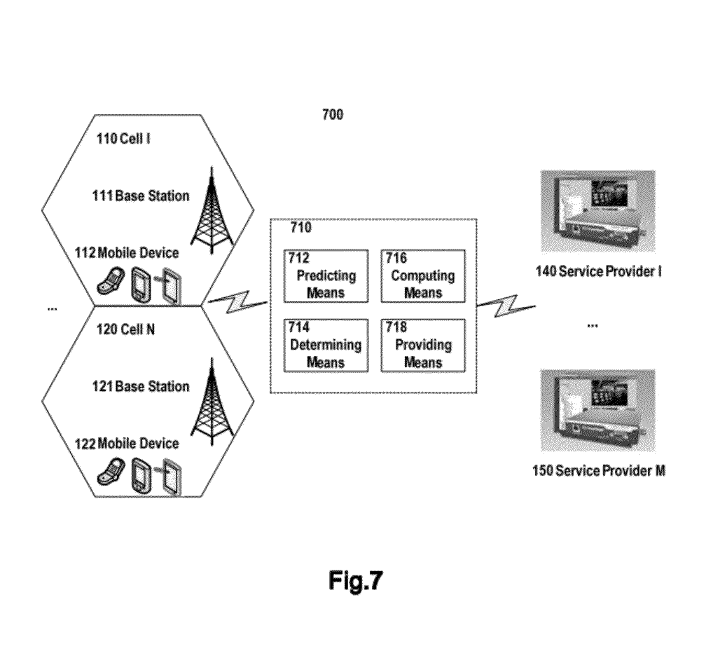

Now, referring to FIG. 7, this figure schematically illustrates a diagram 700 of a system for providing data to a mobile device with a variable coding rate according to an embodiment of the present invention. The embodiment of FIG. 7 discloses an apparatus 710 for providing data to a mobile device. As illustrated in the dotted blocks, the apparatus 710 comprises: predicting means 712 for predicting a list of cells to which a mobile device is to be handed over during a predetermined time period; determining means 714 for determining available bandwidth to the mobile device from at least one cell in the list; calculating means 716 for calculating available traffic to the mobile device from the at least one cell in the list based on the bandwidth; and providing means 718 for providing data to the mobile device based on a coding scheme matching the traffic.

In one embodiment, the means for predicting a list of cells to which a mobile device is to be handed over during a predetermined time period comprises: means for obtaining a historical sequence of cells through which the mobile device passes and road network information within the cells passed and their adjacent cells; and means for predicting a cell to which the mobile device is to be handed over during a predetermined time period based on the historical sequence and road network information to add it into the list.

In one embodiment, a list at least comprises information on identification of a cell to which the mobile device is to be handed over and information on sojourn time in the cell.

In one embodiment, the means for determining the available bandwidth to the mobile device from at least one cell in the list comprises: means for determining the bandwidth based on at least one of the following items: communication capacity, user density, and average channel quality of the at least one cell.

In one embodiment, the means for calculating available traffic to the mobile device from the at least one cell in the list based on the bandwidth comprises: means for calculating the traffic based on the determined bandwidth available to the mobile device from the at least one cell in the list and the expected sojourn time of the mobile device in the at least one cell in the list.

In one embodiment, the means for providing data to the mobile device based on a coding scheme matching the traffic comprises means for selecting a coding scheme where traffic as required by the mobile device for providing data during a predetermined time period does not exceed, but is closest to, the traffic.

In one embodiment, the encoding scheme comprises a scalable encoding scheme.

In one embodiment, the data comprise multimedia data.

In one embodiment, the multimedia data comprise video stream.

It should be noted that although FIG. 7 does not enumerate respective components in the apparatus for providing data to a mobile device with a variable coding rate, those skilled in the art may implement these respective components based on the disclosure of the specification. Besides, respective means as illustrated in FIG. 7 and those not enumerated in FIG. 7 may, in part or all, be located in one or more servers in a mobile communication network, or may be located in a server of a service provider, or may be located in one or more other dedicated devices. According to embodiments of the present invention, physical location of the apparatus for providing data to the mobile device is not limited, and respective means as comprised in this apparatus may be located collectively or distributedly in any suitable physical device, as long as these means can implement the functions as recited in this description as a whole.

In one embodiment, the method for providing data to a mobile device may be initiated in response to a request for accessing a particular type of data from a mobile device user. When the user requests to access multimedia data such as video, for example when the user opens a video player and plays a certain video, the method according to embodiments of the present invention may be initiated.

In one embodiment, the method and apparatus for providing data to a mobile device may be implemented without changing the configuration of the mobile device itself. In the case that the mobile communication network opens to the public the historical state information about accessing the mobile device and the running state information about respective cells, predicting a list of cells, determining available bandwidth, and calculating available traffic may be performed from the information directly obtained from the mobile communication network according to the method of the present invention, thereby implementing the operation of providing data based on a suitable coding scheme. In the case of not requiring the mobile communication network to open information to the public, the historical information may be directly obtained from the mobile device itself in a manner of loading a dedicated application in the mobile device.

It should be noted that although this description employs a scalable coding scheme as an exemplary embodiment for providing data to a mobile device with a variable coding rate, the present invention is not limited to the specific scalable coding scheme in this description, but may comprise any coding scheme which is adapted to different user requirements and preferences, adapted to different mobile device performance, adapted to the conditions of a mobile communication network, and can provide data to a mobile terminal in layers.

It should be further noted that although this description describes the method of the present invention with a video stream as an example of multimedia data, the multimedia data may further comprise for example HD audio data transmitted with variable coding rate, etc.

In implementing the method for providing data to a mobile device, the service provider (such as the service provider I 140) as illustrated in FIG. 7, or a third party development entity capable of implementing the embodiments of the present invention, may deploy a computer program product supporting provision of data to the mobile device on a server device of the mobile communication network provider, further forming an apparatus enabling provision of data to the mobile device. In one embodiment, the apparatus as illustrated in FIG. 7 may be formed by combining computer software products and server hardware. It should be noted that the body for implementing the method and apparatus according to the present invention may be the above service provider, or a third party development entity, or a mobile communication network provider providing a hardware server and network connection services. The mobile communications network provider might not implement the method and apparatus according to the present invention, but only provides a hardware platform and corresponding network services for implementing the method and apparatus of the present invention.

The present invention may adopt a form of hardware embodiment, software embodiment or an embodiment comprising hardware components and software components. In a preferred embodiment, the present invention is implemented as software, including, without limitation firmware, resident software, micro-code, etc.

Moreover, the present invention may be implemented as a computer program product usable from computers or accessible by computer-readable media that provide program code for use by or in connection with a computer or any instruction executing system. For the purpose of description, a computer-usable or computer-readable medium may be any tangible means that can contain, store, communicate, propagate, or transport the program for use by or in connection with an instruction execution system, apparatus, or device.

The medium may be an electric, magnetic, optical, electromagnetic, infrared, or semiconductor system (apparatus or device), or propagation medium. Examples of the computer-readable medium would include the following: a semiconductor or solid storage device, a magnetic tape, a portable computer diskette, a random access memory (RAM), a read-only memory (ROM), a hard disk, and an optical disk. Examples of the current optical disk include a compact disk read-only memory (CD-ROM), compact disk-read/write (CR-ROM), and DVD.

A data processing system adapted for storing or executing program code would include at least one processor that is coupled to a memory element directly or via a system bus. The memory element may include a local memory usable during actually executing the program code, a mass memory, and a cache that provides temporary storage for at least one portion of program code so as to decrease the number of times for retrieving code from the mass memory during execution.

An Input/Output or I/O device (including, without limitation a keyboard, a display, a pointing device, etc.) may be coupled to the system directly or via an intermediate I/O controller.

A network adapter may also be coupled to the system such that the data processing system can be coupled to other data processing systems, remote printers or storage devices via an intermediate private or public network. A modem, a cable modem, and an Ethernet card are merely examples of a currently usable network adapter.

It is to be understood from the foregoing description that modifications and alterations may be made to the respective embodiments of the present invention without departing from the true spirit of the present invention. The description in the present specification is intended to be illustrative and not limiting. The scope of the present invention is limited by the appended claims only.

What is claimed is:

1. A method of providing data to a mobile device, comprising:
predicting a list of cells to which the mobile device is to be handed over during a predetermined time period;
determining bandwidth that is available to the mobile device from at least one cell in the list of cells;
calculating traffic that is available to the mobile device from the at least one cell in the list of cells based on the bandwidth; and
providing the data to the mobile device based on a coding scheme that matches the traffic.

2. The method according to claim 1, wherein predicting a list of cells to which the mobile device is to be handed over during a predetermined time period comprises:
obtaining a historical sequence of cells that the mobile device has passed and road network information of the passed cells and their adjacent cells; and
based on the historical sequence and road network information, predicting a cell to which the mobile device is to be handed over during the predetermined time period for adding into the list.

3. The method according to claim 1, wherein the list comprises at least information on an identification of a cell to which the mobile device is to be handed over and information on expected sojourn time in the cell.

4. The method according to claim 1, wherein determining bandwidth that is available to the mobile device from at least one cell in the list of cells comprises:
determining the bandwidth based on at least one of the following items: communication capacity, user density, and average channel quality of the at least one cell.

5. The method according to claim 1, wherein calculating traffic that is available to the mobile device from the at least one cell in the list of cells based on the bandwidth comprises:
calculating the traffic based on the bandwidth that is available to the mobile device from the at least one cell in the list and on expected sojourn time of the mobile device in the at least one cell in the list.

6. The method according to claim 1, wherein providing the data to the mobile device based on a coding scheme that matches the traffic comprises:
selecting a coding scheme by which traffic as needed by providing the data to the mobile device during a predetermined time period does not exceed, but is closest to, the traffic.

7. The method according to claim 1, wherein the coding scheme comprises a scalable coding scheme.

8. The method according to claim 1, wherein the data comprise multimedia data.

9. The method according to claim 8, wherein the multimedia data comprise a video stream.

10. An apparatus for providing data to a mobile device, comprising:
means configured to predict a list of cells to which the mobile device is to be handed over during a predetermined time period;
means configured to determine bandwidth that is available to the mobile device from at least one cell in the list of cells;
means configured to calculate traffic that is available to the mobile device from the at least one cell in the list of cells based on the bandwidth; and
means configured to provide the data to the mobile device based on a coding scheme that matches the traffic.

11. The apparatus according to claim 10, wherein the means for predicting a list of cells to which the mobile device is to be handed over during a predetermined time period comprises:
means configured to obtain a historical sequence of cells that the mobile device has passed and road network information of the passed cells and their adjacent cells; and
means configured to predict a cell to which the mobile device is to be handed over during the predetermined time period for adding into the list based on the historical sequence and road network information.

12. The apparatus according to claim 10, wherein the list comprises at least information on an identification of a cell to which the mobile device is to be handed over and information on expected sojourn time in the cell.

13. The apparatus according to claim 10, wherein the means configured to determine bandwidth that is available to the mobile device from at least one cell in the list of cells comprises:
means configured to determine the bandwidth based on at least one of the following items: communication capacity, user density, and average channel quality of the at least one cell.

14. The apparatus according to claim 10, wherein the means configured to calculate traffic that is available to the mobile device from the at least one cell in the list of cells based on the bandwidth comprises:
means configured to calculate the traffic based on the bandwidth that is available to the mobile device from the at least one cell in the list and on expected sojourn time of the mobile device in the at least one cell in the list.

15. The apparatus according to claim 10, wherein the means for providing the data to the mobile device based on a coding scheme that matches the traffic comprises:
means configured to select a coding scheme by which traffic as needed by providing data to the mobile device during a predetermined time period does not exceed, but is closest to, the traffic.

16. The apparatus according to claim 10, wherein the coding scheme comprises a scalable coding scheme.

17. The apparatus according to claim 10, wherein the data comprise multimedia data.

18. The apparatus according to claim 17, wherein the multimedia data comprise a video stream.
